(19) United States
(12) Patent Application Publication
(10) Pub. No.: US 2025/0140918 A1
(43) Pub. Date: May 1, 2025

(54) POLYMER FOR GEL-TYPE POLYMER ELECTROLYTE, GEL-TYPE POLYMER ELECTROLYTE INCLUDING SAME, AND SECONDARY BATTERY INCLUDING SAME

(71) Applicant: Konkuk University Industrial Cooperation Corp., Seoul (KR)

(72) Inventors: Jung Tae PARK, Jeonju-si (KR); Juyoung MOON, Seoul (KR); Jaeyeon LEE, Seoul (KR); Eunho SONG, Guri-si (KR); Sanghyuk CHO, Seoul (KR)

(73) Assignee: Konkuk University Industrial Cooperation Corp., Seoul (KR)

(21) Appl. No.: 18/495,191

(22) Filed: Oct. 26, 2023

(51) Int. Cl. H01M 10/0565; H01M 10/0525

(52) U.S. Cl. CPC H01M 10/0565; H01M 10/0525; H01M 2300/0085

(57) ABSTRACT

Proposed is a polymer for a gel-type polymer electrolyte of a secondary battery, in which the polymer is PMVEMA-GMA, which is a polymer obtained by polymerizing (methylvinylether-alt-maleic acid) (PMVEMA) and glycidyl methacrylate (GMA). A gel-type polymer electrolyte including the polymer as a matrix, and a lithium secondary battery including the gel-type polymer electrolyte are also proposed. The polymer of the present disclosure complements a limitation of a liquid electrolyte such as leakage and has a higher ion conductivity than a solid electrolyte. Aside from the advantages, the gel-type polymer electrolyte according to the present disclosure has a higher ion conductivity than a conventional gel-type polymer electrolyte that is based on poly(methylvinylether-alt-maleic acid) (PMVEMA) added with lithium bis(trifluoromethanesulfonyl)imide (LiTFSI) because it can be dissolved well in highly volatile tetrahydrofuran (THF) and thus can be dried at a low temperature.

### BACKGROUND OF THE DISCLOSURE

### 1. Field of the Disclosure

The present disclosure relates to a polymer for a gel-type polymer electrolyte of a secondary battery, a gel-type polymer electrolyte including the same, and a secondary battery including the gel-type polymer electrolyte.

### 2. Description of the Related Art

With the current increased attention on lithium-ion batteries, various types of secondary batteries continue to be developed.

A battery is composed of 4 components: a positive electrode, a negative electrode, an electrolyte, and a separator, out of which electrolyte development has gained a lot of attention.

Until recently, studies on lithium-ion batteries have been focused on liquid electrolyte-based batteries, but liquid electrolyte-based lithium-ion batteries have risks of liquid electrolyte decomposition and leakage at a high potential, which may result in environmental pollution and safety incidents. In order to complement the disadvantages, various solid electrolytes have been developed.

However, a solid phase exhibits less ion mobility than a liquid phase, which means solid electrolytes have a far less electron transport efficiency and a lower ionic conductivity than liquid electrolytes. To compensate for the disadvantages of liquid and solid electrolytes, the inventors have proposed a gel-type electrolyte which is an intermediate phase between a liquid phase and a solid phase. The gel-type electrolyte has a structure in which a liquid electrolyte is contained in a polymer template.

Various attempts have been made to use a polymer with a functional group as an electrolyte to enhance the ion mobility within the gel-type electrolyte. Among the functional groups, oxygen-containing functional groups have a tendency of exhibiting high performance, which is because d-oxygen atoms help lithium ions to hop because lithium ions are stable when existing as cations.

### DOCUMENTS OF RELATED ART

### Patent Document

(Patent Document 1) Korean Patent Application Publication No. 10-2001-0036762 (Publication date: 2001.05.07)
(Patent Document 2) Korean Patent Application Publication No. 10-2002-0071203 (Publication date: 2002.09.12)

### SUMMARY OF THE DISCLOSURE

The objective of the present disclosure is to provide a polymer for a matrix, the polymer designed to overcome problems such as leakage of commercially available liquid electrolytes and to have a higher ion conductivity than conventional solid electrolytes, thereby enabling implementation of a gel-type polymer electrolyte. The present disclosure is also to provide a gel-type polymer electrolyte including the same polymer and a secondary battery including the gel-type polymer electrolyte.

To accomplish the objective, the present disclosure proposes a polymer for a gel-type electrolyte of a secondary battery, the polymer being PMVEMA-GMA resulting from polymerization of poly(methylvinylether-alt-maleic acid (PMVEMA) and glycidyl methacrylate (GMA).

The PMVEMA-GMA may be synthesized by a dehydration reaction between a hydroxide of a carboxyl group on the surface of the PMVEMA and a hydroxide of the GMA through a ring opening reaction, and the PMVEMA-GMA has sufficient C═O functional groups having an oxygen atom.

A gel-type polymer may be prepared by reacting the PMVEMA and the GMA in a weight ratio of 1:1 to 1:10 during the synthesis of the PMVEMA-GMA.

Another aspect of the present disclosure relates to a gel-type polymer electrolyte for a lithium secondary battery, the gel-type polymer electrolyte including: the PMVEMA-GMA according to the present disclosure, a lithium salt, and an organic solvent.

Here, the lithium salt may include Lit as a cation and one or more selected from the group consisting of F⁻, Cl⁻, Br⁻, BF₄⁻, NO₃⁻, N(CN)₂⁻, ClO₄⁻, AlO₄⁻, AlCl₄⁻, PF₆⁻, SbF₆⁻, ASF₆⁻, BF₂C₂O₄⁻, BC₄O₈⁻, (CF₃)₂⁻PF₄⁻, (CF₃)₃PF₃⁻, (CF₃)PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCAN⁻ and (CF₃CF₂SO₂)₂N⁻ as an anion.

Specific examples of the lithium salt may include LiClO₄, LiPF₆, LiCF₃CF₂SO₃, Li(CF₃SO₂)₂N, Li(ESO₂)₂N, LiCF₃(CF₂)₇SO₃, and Li(CF₃CF₂SO₂)₂N.

In addition, the organic solvent included in the gel-type polymer electrolyte may is not particularly limited if it is hardly decomposed by an oxidation reaction during charging and discharging of a secondary battery and can exhibit the intended characteristics in conjunction with additives added to the electrolyte, if necessary. For example, the organic solvent may be any one selected from the group consisting of an ether-based solvent, an ester-based solvent, an amide-based solvent, or a mixture of at least two of those.

The gel-type polymer electrolyte according to one embodiment of the present disclosure may further include at least one or more additive selected from the group consisting of N,N′-dicyclohexylcarbodimide (DCC), vinylene carbonate, saturated sultone, and cyclic sulfate, which are compounds capable of inhibiting a side reaction on the films of the positive and negative electrodes.

In addition, the gel-type polymer electrolyte according to one embodiment of the present disclosure may further include at least one additive for SEI film formation, if necessary, selected from the group consisting of noncyclic sulfones (divinyl sulfone, dimethyl sulfone, diethyl sulfone, methyl ethyl sulfone, or methyl vinyl sulfone), alkyl silyl compounds (tri (trimethylsilyl)phosphate, tri (trimethylsilyl)phosphite, tri (triethylsilyl)phosphate, tri (triethylsilyl)phosphite, tri (trimethylsilyl) borate, or tri (triethylsilyl) borate, and so on), and inorganic compounds (lithium difluoro (bisoxalate)phosphate, lithium difluoro phosphite, lithium tetrafluoro oxalate phosphate, lithium bis(fluorosulfonyl)imide, and lithium bis(trifluoromethylsulfonyl)imide).

On top of that, in a further aspect of the present disclosure, the present disclosure provides a lithium secondary battery including a positive electrode, a negative electrode, a separator interposed between the positive electrode and the negative electrode, and the gel-type polymer electrolyte according to the present disclosure.

The lithium secondary battery may be manufactured by injecting a gel-type polymer electrolyte including the PMVEMA-GMA as a matrix into an electrode assembly in which a positive electrode and aa negative electrode are stacked, and a separator is optionally interposed between the positive electrode and the negative electrode.

Herein, as the positive electrode, the negative electrode, and the separator that constitute the electrode assembly may be a positive electrode, a negative electrode, and a separator commonly used in conventional lithium secondary batteries, respectively.

The positive electrode may be manufactured by forming a layer of a positive electrode raw material mixture on a positive electrode current collector. The positive electrode raw material mixture layer may be formed by coating the surfaces of the positive electrode current collector with a positive electrode slurry containing a positive electrode active material, a binder, a conductive material, and a solvent and then drying and rolling the coated current collector.

The material of the positive electrode current collector is not particularly limited if it does not cause chemical changes in the battery cell and has electrical conductivity. Stainless steel, aluminum, nickel, titan, calcined carbon, or aluminum or stainless steel coated with carbon, nickel, titan, or silver may be used for the positive electrode current collector.

The positive electrode active material is a compound allowing reversible intercalation and deintercalation of lithium. Specifically, the positive electrode active material may contain a lithium composite metal oxide including lithium and one or more metals selected from the group consisting of cobalt, manganese, nickel, or aluminum. To be more specific, examples of the lithium composite metal oxide include lithium-manganese oxides (for example, LiMnO₂, LiMn₂O₄), lithium-cobalt oxides (for example, LicoO₂), lithium-nickel oxides (for example, LiNiO₂), lithium-nickel-manganese oxides, lithium-nickel-cobalt oxides, lithium-manganese-cobalt oxides, lithium-nickel-manganese-cobalt oxides, and lithium-nickel-cobalt-transition metal oxides.

The binder is a component serving as a helper for binding the active material to a conductive additive or to a current collector. For example, various copolymers such as polyvinylidene fluoride (PVDF), polyvinyl alcohol, carboxymethyl cellulose (CMC), starch, hydroxypropyl cellulose, regenerated cellulose, polyvinylpyrrolidone, tetrafluoroethylene, polyethylenpolypropylene, ethylene-propylene-diene terpolymer (EPDM), sulfonated EPDM, styrene-butadiene rubber, and fluorinated rubber can be used as the binder.

In addition, the conductive material is not particularly limited if the conductive material does not cause a chemical change in the battery cell and has electrical conductivity. Examples of the conductive material that can be used include carbon-based materials such as graphite, carbon black, acetylene black, Ketjen black, channel black, furnace black, lamp black, and thermal black; conductive fibers such as carbon fiber and metal fiber; and metal powders such as aluminum and nickel.

The negative electrode may be manufactured by forming a layer of a negative electrode raw material mixture on a negative electrode current collector, and the negative electrode raw material mixture layer may be formed by coating the negative electrode current collector with a negative electrode slurry including a negative electrode active material, a binder, a conductive material, and a solvent and then drying rolling the current collector.

The material of the negative electrode current collector is not particularly limited if it does not cause chemical changes in the battery cell and has electrical conductivity. Examples of the negative electrode current collector may include copper, stainless steel, aluminum, nickel, titan, calcined carbon, or copper or stainless steel whose surfaces are coated with carbon, nickel, titan, or silver, or aluminum-cadmium alloy.

Examples of the negative electrode active material include: carbon-based materials such as carbon, synthetic graphite, and natural graphite; lithium-containing titanium composite oxides; and metal oxides such as a silicon-based alloy, a tin-based alloy, Sno, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅.

The binder is a component serving as a helper for binding a conductive additive, an active material, and a current collector. Examples of the binder include various copolymers such as polyvinylidene fluoride (PVDF), polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber, and fluorinated rubber.

The conductive material is a component to further enhance the conductivity of the negative electrode active material. Examples of the conductive material include graphite such as natural or synthetic graphite; carbon-based materials such as acetylene black, Ketjen black, channel black, furnace black, lamp black, and thermal black; conductive fibers such as carbon fiber and metal fiber; and metal powders such as aluminum and nickel.

The solvent may be water or an organic solvent such as NMP and alcohol.

The separator serves to prevent internal short-circuiting between the electrodes and to bear an electrolyte. The formation of the separator involves: preparation of a separator composition by mixing a polymer resin, a filler, and a solvent; and formation of a separator film by directly application and drying of the separator composition on the surface of an electrode, or casting and drying of the separator composition on a support and lamination of the separator film separated from the support on an electrode.

The separator may be a single-layered or multi-layered porous polymer film which is made of polyolefin-based polymers such as ethylene homopolymers, propylene homopolymers, ethylene/butene copolymers, ethylene/hexene copolymers, and ethylene/methacrylate copolymers.

Meanwhile, the external shape of the lithium secondary battery is not particularly limited and may be any shape such as a cylinder type using a can, a prismatic type, a pouch type, and a coin type.

The gel-type polymer electrolyte according to the present disclosure complements limitations of a liquid electrolyte, such as leakage and has a higher ion conductivity than a solid electrolyte. Aside from the advantages, the gel-type polymer electrolyte according to the present disclosure has a higher ion conductivity than a conventional gel-type polymer electrolyte that is based on poly(methylvinylether-alt-maleic acid) (PMVEMA) added with lithium bis(trifluoromethanesulfonyl)imide (LiTFSI) because it can be dissolved well in highly volatile tetrahydrofuran (THF) and thus can be dried at a low temperature.

### BRIEF DESCRIPTION OF THE DRAWINGS

FIG. 1 is a schematic diagram illustrating a PMVEMA-GMA polymer preparation process using a ring opening reaction;

FIGS. 2A and 2B illustrate changes in molecular structure of PMVEMA and PMVEMA-GMA before and after synthesis (2A: FT-IR, and 2B: H1NMR);

FIG. 3 is a gel permeation chromatography (GPC) analysis result of the synthesized PMVEMA-GMA; and

FIGS. 4A and 4B are an X-ray diffraction (XRD) graph and a differential scanning calorimetry (DSC) graph of the synthesized PMEVMA-GMA polymer, respectively.

### DESCRIPTION OF THE PREFERRED EMBODIMENTS

In the following description of the present disclosure, detailed descriptions of known functions and components incorporated herein will be omitted when it may make the subject matter of the present disclosure unclear.

Reference will now be made in detail to various embodiments of the present disclosure, specific examples of which are illustrated in the accompanying drawings and described below, since the embodiments of the present disclosure can be variously modified in many different forms. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

The terminology used herein is for the purpose of describing particular embodiments only and is not intended to be limiting. As used herein, the singular forms “a,” “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described in more detail with reference to examples.

The present disclosure may be embodied in many different forms and should not be construed as being limited to the embodiments set forth herein. The embodiments of the present disclosure described hereinbelow is provided for allowing those skilled in the art to more clearly comprehend the present invention.

### Examples

### Synthesizing PMVEMA-GMA by Using Ring Opening Reaction

PMVEMA-GMA is synthesized through a ring-opening mediated dehydration reaction with a hydroxide of carboxyl groups on the surface of PMVEMA and a hydroxide of GMA.

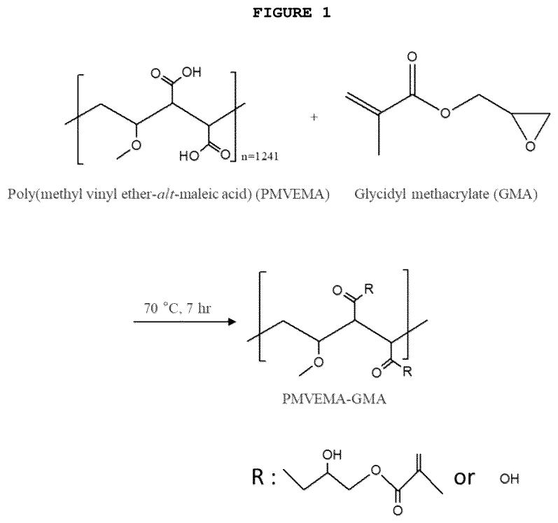

GMA is a polymer with an epoxy group. GMA can be linked to various polymers through a ring opening reaction to form a new molecular structure for use. PMVEMA is dissolved in water and ethanol, but it is not dissolved in highly volatile THF. PMVEMA is highly crystalline so that it has a very poor ion conductivity. By polymerizing PMVEMA and GMA, a polymer being little crystalline and being soluble in THE is synthesized. FIG. 1 is a structural formula illustrating the synthesis of such a polymer.

Specifically, 3 g of PMVEMA was placed in a 100 ml round flask with 50 ml of ethanol contained and was sufficiently dissolved for 8 hours. After the complete dissolution of PMVEMA, GMA was added to each of the flasks. To the respective flasks, GMA was added in amounts of 9 g, 15 g, 21 g, and 30 g (weight ratio of 1:1, 1:3, 1:5, 1:7, and 1:10, respectively). The flasks were subjected to nitrogen purging of 2 hours or more so that the oxygen inside the flasks was replaced with nitrogen. Afterwards, a reaction proceeded for 3 hours to 7 hours at a temperature of 50° C. or 70° C. After the reaction, precipitation was carried out in a n-hexane solution or a mixed solution of n-hexane and benzene to obtain a polymer, which in turn was dried for 24 hours or more in a vacuum oven without heat application. The synthesized polymer is called PMVEMA-GMA.

Preparing Gel-Type Polymer Matrix with Lithium-Ion Included by Using Synthesized PMVEMA-GMA

The polymer was dissolved well in an amount of 10% by mass in an organic solvent (DMF, THE). A lithium salt (LiTFSI) was dissolved in an amount of 20% by mass based on the total mass of the polymer and casted onto a stainless steel. Next, the casted polymer was dried at a temperature of 50° C. or 80° C., followed by measurement.

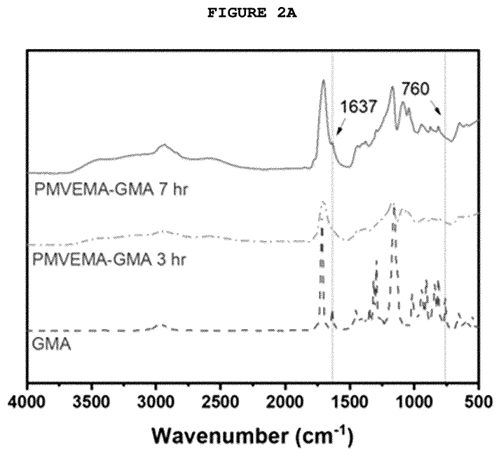

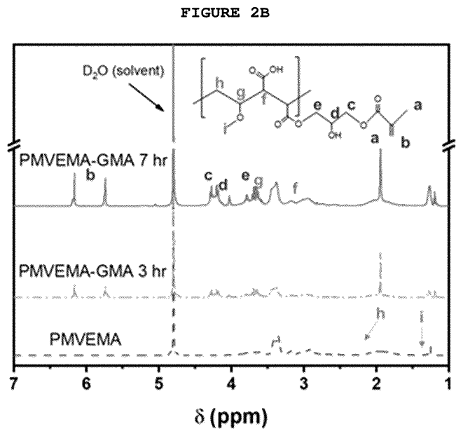

Referring to the FT-IR analysis result shown in FIG. 2A, GMA showed an epoxy group-specific band at 760 cm⁻¹. After GMA grafting to PMVEMA, disappearance of the band was confirmed. The 1637 cm⁻¹ band is related to a C═C bond within the GMA structure. Through the observation, GMA was identified to be successfully grafted to PMVEMA.

Even with the NMR structure body shown in FIG. 2B, successfully synthesized PMVEMA-GMA was able to be identified. An epoxy ring peak usually found in a concentration of 3.0 ppm was not made, and a total of 5 peaks for GMA were able to be identified. As shown in FIG. 2B, hydrogen exhibited a doublet-shaped peak, which was because a double-bond was impossible to make a rotation and was represented by a double-line. When a polymerization ratio was calculated through NMR, the ratios of GMA:PMVEMA were 1.25:1 (by molecular weight) and 1.14:1 (by weight).

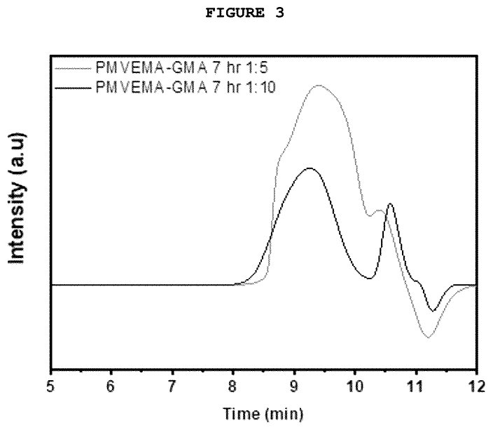

FIG. 3 is a graph of GPC measured after polymer synthesis of PMVEMA and GMA in a weight ratio of 1:5 and 1:10. Since PMVEMA was not dissolved, GPC measurement of PMVEMA was not measured. After the synthesis, rises in Mw and Mn in the GPC phase were identified. In the case of synthesis in a ratio of 1:10, due to a low amount of the solvent able to be synthesized, when a reaction was carried out with the same amount, no substantial polymerization was determined to proceed. Meanwhile, in the case of synthesis in a ratio of 1:5, other peaks than the peak found in a molecular weight range of PMVEMA were shown, which means a successful polymer synthesis.

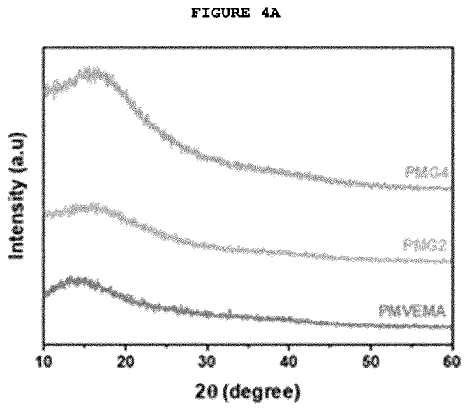

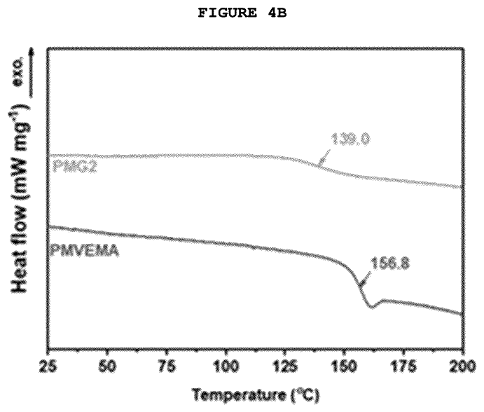

FIGS. 4A and 4B illustrate the results of comparison in crystallinity of PMVEMA and polymers observed through XRD and DSC, in which the polymers were synthesized with PMVEMA and GMA in weight ratios of 1:2 and 1:4, respectively. The polymer synthesized with PMVEMA and GMA in a weight ratio of 1:2 exhibited a significantly lower crystallinity than PMVEMA, and the polymer synthesized with PMVEMA and GMA in a weight ratio of 1:4 exhibited an increased crystallinity which means no suitable weight ratio for use for an electrolyte. In addition, when the glass transition points of the polymers were measured through DSC, a crystallinity decrease was identified compared with PMVEMA. The polymer synthesized with PMVEMA and GMA in a weight ratio of 1:2 was found to have a remarkable low crystallinity through the two measurements, and thus this polymer is expected to be used as a gel-type electrolyte with good performance.

The Table 1 below showed ion conductivity of electrolytes dried at a high temperature of 80° C. after the dissolution of each of PMVEMA and PMVEMA-GMA into DMF. The measurements were very low, which is due to vaporization of most of the solvent capable of being used as an ion transport channel in the case of drying at a high temperature. This means that high temperature drying made the electrolytes similar to solid electrolytes.

TABLE 1
Lithium-ion conductivity of PMVEMA-
GMA polymer dissolved in DMF

| | Inonic conductivity (S/cm) |
|---|---|
| PMVEMA-GMA 7 hr | 0.196 × 10⁻⁶ |
| PMVEMA-GMA 3 hr | 0.355 × 10⁻⁶ |
| PMVEMA | 0.0509 × 10⁻⁶ |

Meanwhile, Table 2 showed ion conductivity of the electrolytes dried at a low temperature after the dissolution into THE. PMVEMA was not dissolved into THE so that a direct comparison was impossible. Ion conductivity in the case of drying at a temperature of 50° C. was very high. It is assumed that such a high ion conductivity result was obtained because GMA was able to be dissolved in THE after its synthesis and was able to be dried at a low temperature.

TABLE 2
Lithium-ion conductivity of PMVEMA-
GMA polymer dissolved in THF

| | Inonic conductivity (S/cm) |
|---|---|
| PMVEMA-GMA 7 hr | 2.35 × 10⁻³ |

Conventional backbones tend to be dissolved in water or alcohol. However, after GMA synthesis, it was found that the backbones were dissolved in various organic solvents such as benzene or THF, which showed a high possibility in more versatile use of polymers. In the present disclosure, the synthesized polymers are dissolved in highly volatile THE using the same properties, and as a result, an electrolyte membrane with a high ion conductivity can be developed.

The present disclosure is not limited to the described examples, and may be manufactured in many other forms. The ordinarily skilled in the art will understand that the present disclosure may be implemented in other specific forms without departing from the technical ideas or essential features of the present disclosure. Therefore, it should be understood that the examples described above are illustrative in all aspects and are not restrictive.

What is claimed is:

1. A polymer for a gel-type polymer electrolyte of a secondary battery, the polymer comprising PMVEMA-GMA which is polymerized from poly(methylvinylether-alt-maleic acid) (PMVEMA) and glycidyl methacrylate (GMA).

2. The polymer of claim 1, wherein the gel-type polymer electrolyte is synthesized by reacting the PMVEMA and the GMA in a weight ratio of 1:1 to 1:10.

3. A gel-type polymer electrolyte comprising the polymer of claim 1, a lithium salt, and an organic solvent.

4. The gel-type polymer electrolyte of claim 3, wherein the lithium salt is lithium bis(trifluoromethanesulfonyl)imide (LiTFSI), and the organic solvent is tetrahydrofuran (THE).

5. A lithium secondary battery comprising a positive electrode, a negative electrode, a separator interposed between the positive electrode and the negative electrode, and the gel-type polymer electrolyte of claim 3.
